(19) United States
(12) Patent Application Publication
(10) Pub. No.: US 2005/0117331 A1
(43) Pub. Date: Jun. 2, 2005

(54) Light housing

(76) Inventor: Ed Haas, Innerkip (CA)

Correspondence Address: VALENTINE A. COTTRILL, SUITE 1020 50 QUEEN STREET NORTH, KITCHENER, ON, N2H6M2, CA

(21) Appl. No.: 10/722,445

(22) Filed: Nov. 28, 2003

(51) Int. Cl. F21S 8/00; F21V 21/00

(52) U.S. Cl. 362/147; 362/145; 362/249

(57) ABSTRACT

A housing for holding at least one light source. The housing has a front wall with an exterior side and an opposed interior side, a first wall extending from the front wall, and one or more support elements for locating said at least one light source in the housing. Each support element extends from the interior side of the front wall.

### FIELD OF THE INVENTION

This invention relates to light housings and, more particularly, a housing for holding a light source which is adapted for attachment to a structure.

### BACKGROUND OF THE INVENTION

Many devices are known for attachment to a structure, such as an exterior of a house, in which electric lights can be positioned. For example, U.S. Pat. No. 5,813,751 (Shaffer)-discloses a device including an elongate channel having top and bottom walls joined by a rear wall and a front wall depending from the top wall. The device also includes a flexible, rectangular screen cover. A string of Christmas lights is positionable in the channel, when the cover screen is removed.

The invention disclosed in Shaffer suffers from the defect that it is relatively inconvenient to position the Christmas lights in the device, because the positioning is effected by means of cord clamps. The device includes a main body which is fastened to a structure using fasteners, such as screws. However, the cord clamps also include screws which have to be tightened so that they will hold the Christmas lights. Also, the main body of the device includes two portions—a body defining a channel, as well as the screen cover—so that the user is required to handle two components on installation, as well as fasteners and the cord clamps, and the screws needed for the cord clamps. In addition, the Shaffer device is adapted to permit light to be transmitted through the screen cover only, and the lighting effects which can be produced using the Shaffer device are therefore somewhat limited.

There is therefore a need for a simple housing adapted for attachment to a structure adapted for holding a light source therein.

### SUMMARY OF THE INVENTION

In a broad aspect of the present invention, there is provided a housing for holding at least one light source. The housing has a front wall with an exterior side and an opposed interior side, a first wall extending from the front wall and one or more support elements extending from the interior side of the front wall. Each support element is adapted to locate one or more sources in the housing.

In another embodiment, the first wall extends from the interior side of the front wall.

In yet another embodiment, the front wall includes a plurality of apertures so that light from the light source held in the housing is transmittable through the apertures in the front wall.

In another alternative embodiment, each support element comprises a tab movable between an open position, in which the light source is receivable on the tab, and a closed position, in which the tab holds the light source in the housing.

In yet another alternative embodiment, the housing additionally includes a second wall extending from the interior side of the front wall. The second wall is spaced apart from the first wall a predetermined distance sufficient to permit the light source to be received therebetween.

### BRIEF DESCRIPTION OF THE DRAWINGS

The invention will be better understood with reference to the drawings, in which:

FIG. 1A is an isometric view of a preferred embodiment of a housing of the invention showing an interior side of a front wall, a first wall extending from the front wall, and a support element extending from the interior side of the front wall;

FIG. 1B is another isometric view of the housing of FIG. 1A showing the first wall and an exterior side of the front wall;

FIG. 1C is a cross-section of the housing of FIG. 1A attached to a structure and with a light source held therein, drawn at a smaller scale;

FIG. 1D is an isometric view of the housing of FIG. 1A with a fastener positioned to be passed through the support element and through a fastener hole in the first wall, drawn at a larger scale;

FIG. 1E is an isometric view of the housing and the fastener of FIG. 1D, showing an exterior side of the front wall and the first wall;

FIG. 1F is a cross-section of the housing of FIG. 1E showing the housing positioned adjacent to the structure, with the fastener positioned to be passed through the support element and through the fastener hole into the structure, drawn at a smaller scale;

FIG. 2 is a isometric view of a structure to which a series of housing portions are attached to the structure in preselected locations drawn at a smaller scale;

FIG. 3 is a side view of the housing of FIG. 1A, with a light source held therein and attached to the structure of FIG. 2 schematically showing light-from the light source transmitted through openings in the housing, drawn at a larger scale;

FIG. 4 is a side view of the housing and light assembly of FIG. 3 with the light source positioned therein, drawn at a larger scale;

FIG. 5A is an isometric view of an alternative embodiment of the housing of the invention, drawn at a larger scale;

FIG. 5B is an elevation view of the front wall of the housing of FIG. 5A;

FIG. 5C is a cross-section of the housing of FIG. 5A attached to the structure and with the light source held therein, drawn at a smaller scale;

FIG. 6A is an isometric view of another alternative embodiment of the housing of the invention, showing an exterior side of a front wall with two substantially planar portions positioned at a predetermined angle relative to each other, drawn at a larger scale;

FIG. 6B is another isometric view of the housing of FIG. 6A;

FIG. 6C is a cross-section of the housing of FIG. 6A attached to the structure and with the light source held therein, drawn at a small scale;

FIG. 7A is an isometric view of another alternative embodiment of the housing of the invention, drawn at a larger scale;

FIG. 7B is another isometric view of the housing of FIG. 7A;

FIG. 7C is a cross-section of the housing of FIG. 7A attached to the structure and with-the light source held therein, drawn at a smaller scale;

FIG. 8A is an isometric view of another alternative embodiment of the housing of the invention, drawn at a larger scale;

FIG. 8B is another isometric view of the housing of FIG. 8A;

FIG. 8C is a cross-section of the housing of FIG. 8A attached to the structure and with the light source held therein, drawn at a smaller scale;

FIG. 9A is an isometric view of another alternative embodiment of the housing of the invention, drawn at a larger scale;

FIG. 9B is another isometric view of the housing of FIG. 9A;

FIG. 9C is a cross-section of the housing of FIG. 9A attached to the structure and with the light source held therein, drawn at a smaller scale;

FIG. 10A is an isometric view of yet another alternative embodiment of the housing of the invention, curved to conform to a curvilinear structure, drawn at a larger scale;

FIG. 10B is a top elevation view of the housing of FIG. 10A;

FIG. 10C is a front elevation view of the housing of FIG. 10A;

FIG. 10D is another isometric view of the housing of FIG. 10A, mounted on a curved surface of a structure, drawn at a smaller scale;

FIG. 11A is an isometric view of another alternative embodiment of the housing of the invention, drawn at a larger scale;

FIG. 11B is another isometric view of the housing of FIG. 11A;

FIG. 11C is a cross-section of the housing of FIG. 11A attached to the structure and with the light source held therein, drawn at a smaller scale;

FIG. 12A is an isometric view of another alternative embodiment of the housing of the invention, drawn at a larger scale;

FIG. 12B is another isometric view of the housing of FIG. 12A;

FIG. 12C is a cross-section of the housing of FIG. 12A attached to the structure and with the light source held therein, drawn at a smaller scale;

FIG. 13A is an isometric view of another alternative embodiment of the housing of the invention, drawn at a larger scale;

FIG. 13B is another isometric view of the housing of FIG. 13A;

FIG. 13C is a cross-section of the housing FIG. 13A attached to the structure and with the light source held therein, drawn at a smaller scale;

FIG. 14A is an isometric view of another alternative embodiment of the housing of the invention, drawn at a larger scale;

FIG. 14B is another isometric view of the housing of FIG. 14A;

FIG. 14C is a cross section of the housing of FIG. 14A attached to the structure and with the light source held therein, drawn at a smaller scale;

FIG. 15A is an isometric view of another alternative embodiment of the housing of the invention, drawn at a larger scale;

FIG. 15B is another isometric view of the housing of FIG. 15A;

FIG. 15C is a cross-section of the housing of FIG. 15A attached to the structure and with the light source held therein, drawn at a smaller scale;

FIG. 16A is an isometric view of another alternative embodiment of the housing of the invention, drawn at a larger scale;

FIG. 16B is another isometric view of the housing of FIG. 16A;

FIG. 16C is a cross-section of the housing of FIG. 16A attached to the structure and with the light source held therein, drawn at a smaller scale;

FIG. 17A is an isometric view of another alternative embodiment of the housing of the invention, curved to conform to a curved surface formed by an arch structure, drawn at a larger scale;

FIG. 17B is another isometric view of the housing of FIG. 17A;

FIG. 17C is an elevation view of a front wall of the housing of FIG. 17A;

FIG. 17D is an isometric view of the housing of FIG. 17A attached to an arch structure, drawn at a smaller scale;

FIG. 18A is an isometric view of a housing and light assembly, drawn at a larger scale;

FIG. 18B is another isometric view of the housing and light assembly of FIG. 18A;

FIG. 19A is an isometric view of an alternative embodiment of a housing and light assembly of the invention;

FIG. 19B is another isometric view of the housing and light assembly of FIG. 19A;

FIG. 20A is an isometric view of an alternative embodiment of a housing and light assembly of the invention;

FIG. 20B is another isometric view of the housing and light assembly of FIG. 20A;

FIG. 21A is an isometric view of an alternative embodiment of a housing and light assembly of the invention; and

FIG. 21B is another isometric view of the housing and light assembly of FIG. 21A.

### DETAILED DESCRIPTION OF THE PREFERRED EMBODIMENT(S)

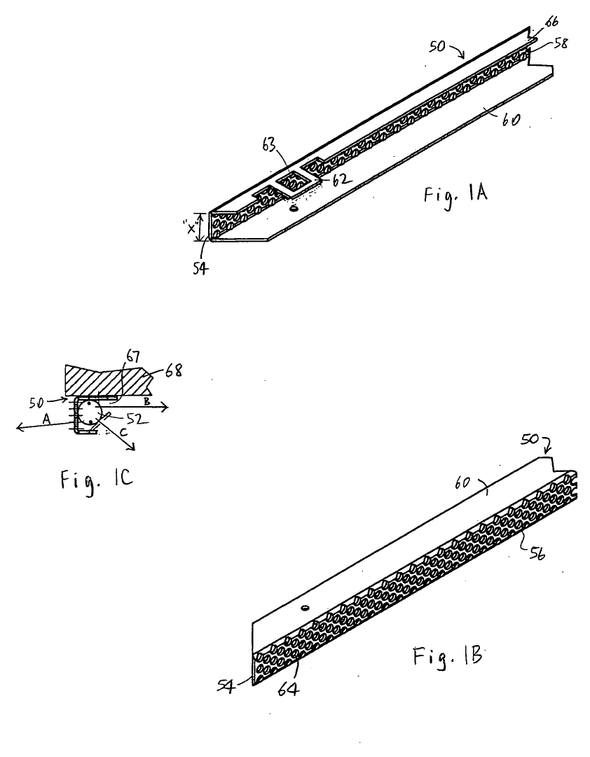

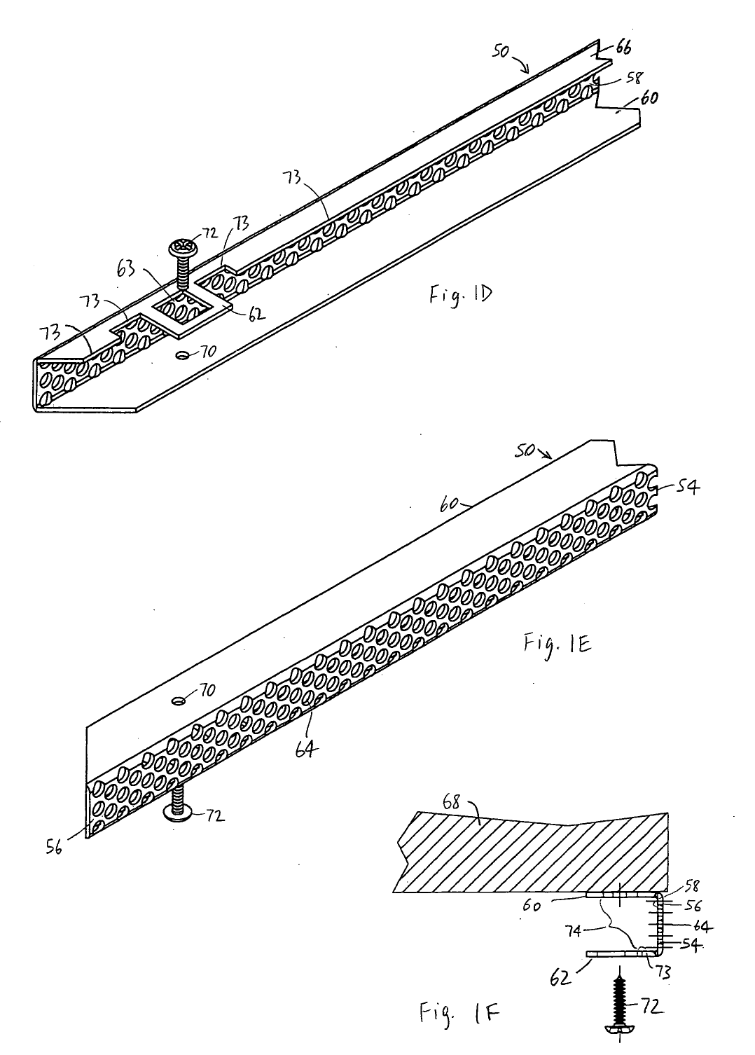

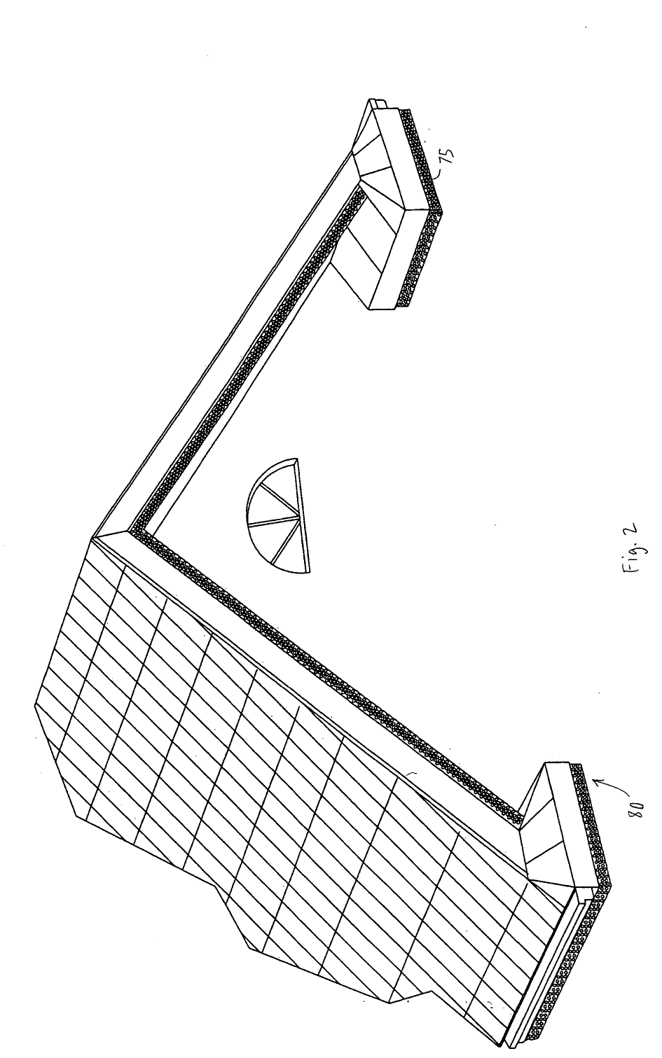

Reference is first made to FIGS. 1A-1F to describe a preferred embodiment of a housing indicated generally by the numeral 50 in accordance with the invention. As can be seen in FIG. 1C, the housing 50 is adapted for holding a light source 52 in the housing 50. The housing 50 has a front wall 54 with an exterior side 56 (FIG. 1B) and an opposed interior side 58 (FIG. 1A) and a first wall 60 extending from the front wall 54. Preferably, the first wall 60 extends from the interior side 58 of the front wall 54.

In the preferred embodiment, the housing 50 also includes a second wall 66 extending from the front wall 54 (FIG. 1A). Preferably, the second wall 66 is spaced apart from the first wall 60 a predetermined distance sufficient to permit the light source 52 to be received therebetween.

The second wall 66 includes a support element 62 for locating the light source 52 in the housing 50. As can be seen in FIGS. 1A and 1C, the support element 62 preferably is a tab movable between an open position (FIG. 1A), in which the light source 52 is receivable between the tab 62 and the first wall 60, and a closed position (FIG. 1C), in which the tab 62 holds the light source 52 in the housing 50. The tab 62 is shown in the open position in FIG. 1D and in the closed position in FIG. 1C. The tab 62 preferably includes an opening 63 (FIG. 1A), as will be described.

As can be seen in FIGS. 1A and 1B, the front wall 54 preferably includes a number of apertures 64. The apertures 64 are positioned so that, when the light source 52 is held in the housing 50, light from the light source 52 is transmittable through the apertures 64. Light transmitted through the apertures 64 is schematically represented in FIG. 1C by arrow “A”.

For example, the first wall 60 and the second wall 66 are shown in FIGS. 1A and 1C as being spaced apart a distance “X” which is sufficient to permit the light source 52 (shown in FIG. 1C) to be received therebetween.

In the preferred embodiment, the first wall 60 is substantially planar. Preferably, the second wall 66 is also substantially planar. The second wall 66 can extend from the interior side 58 of the front wall 54 substantially parallel to the first wall 60 and spaced apart from the first wall 60 a predetermined distance sufficient to permit the light source 52 to be received therebetween. Preferably, the support element 62 is substantially coplanar with the second wall 66.

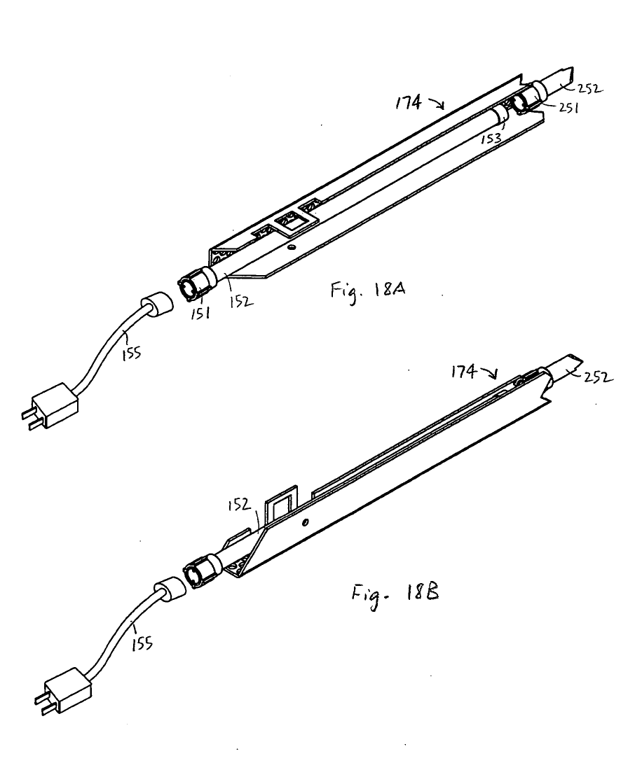

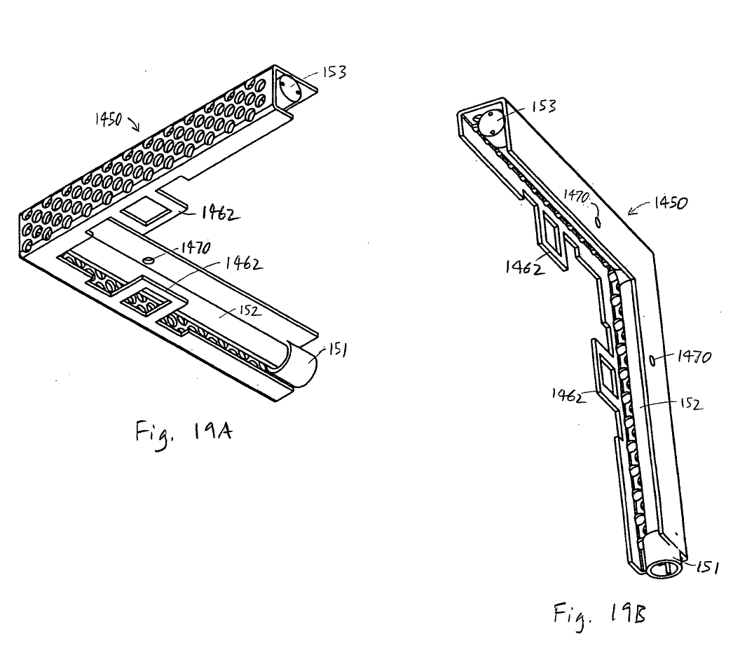

As can be seen in FIGS. 1C and 18A, when the light source 52 is held in the housing 50 by the support element 62, a gap 67 is defined between the second wall 66 and the first wall 60. Light, schematically represented by arrow “B” (FIG. 1C), is simultaneously transmitted from the light source 52 through the gap 67 and the apertures 64. The result is an aesthetically pleasing backlighting effect.

The opening 63 in the tab 62 also permits light from the light source 52 to be transmitted generally in substantially the same direction as light transmitted through the gap 67. Light from the light source 52 which is transmitted through the opening 63 is schematically represented in FIG. 1C by arrow “C”. It will be appreciated that light is also transmitted from the light source 52 substantially parallel to arrow “C” along the length of the light source 52, except where blocked by the support element 62.

For example, as can be seen in FIG. 1F, the second wall 66 includes a back edge 73 (FIG. 1D) which, together with the first wall 60, defines an opening 74. When the light source 52 is located in the housing 50 (i.e., as shown in FIG. 1C), light from the light source 52 is transmittable through the opening 74. The only obstructions to this transmission of light from the light source 52 through the opening 74 along the light source's length are the support elements 62.

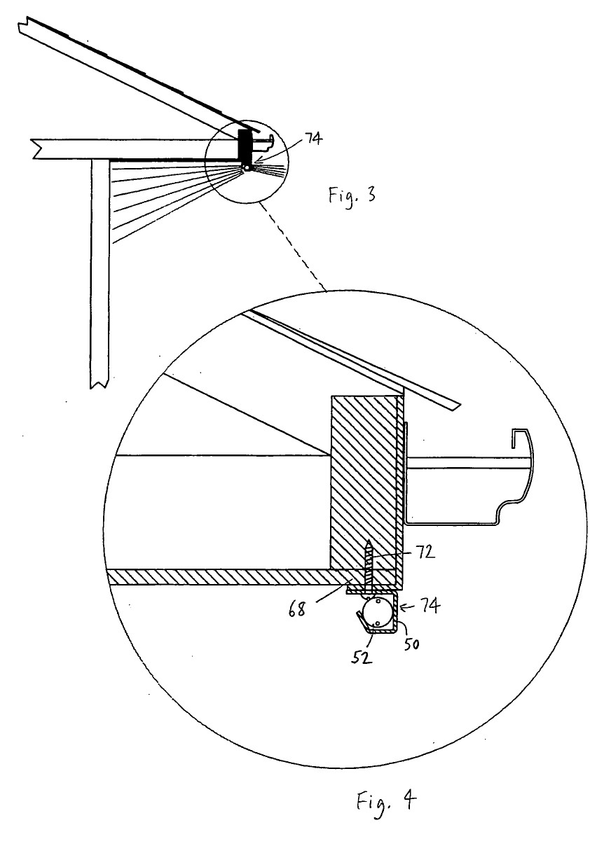

In the preferred embodiment, the first wall 60 is adapted to be secured to a structure 68 (FIGS. 1C, 1F, 2, 3 and 4). Preferably, the first wall 60 includes a fastener hole 70 in which a fastener 72, such as a screw, is receivable. As shown in FIG. 1D, the tab 62 is preferably positioned so that the fastener 72 can be aligned with the fastener hole 70 through the opening 63 in the tab 62, thereby simplifying the installation of the housing 50 on the structure 68. An installer (not shown), who is typically positioned on a ladder when attaching the housing 50 to the structure 68, need only insert the fastener through the opening 63 and directly into the fastener hole 70 (FIGS. 1E, 1F). The fastener 72 in the fastener hole 70 is subsequently tightened until the fastener 72 secures the first wall 60 to the structure 68.

It will be understood that the various embodiments of the housings shown as being attached to the structure in the drawings are attached thereto by any suitable fasteners, and/or by any other suitable means. As many fastener holes 70 and fasteners 72 as are needed along a length of housing 50 are used. It will also be understood that, although only one support element is shown in a housing in the drawings, housings are typically formed to be elongate, and typically include a plurality of support elements. The support elements are typically spaced apart along a length of a housing at predetermined intervals sufficient to hold the light source securely in the housing.

The housing 50 is preferably included in a housing and light assembly 74 (FIGS. 2-4, 18A, and 18B) including the front wall 54, the first wall 60 and the tabs 62, as well as one or more light sources 52 held in the housing 50. The light source 52 is preferably held against the interior side 58 of the front wall 54 by support elements, or tabs, 62. Also, the light source 52 is preferably adapted for use with an external source of electric current, as will be described.

Preferably, a number of housing and light assemblies 74, or housing portions, are positioned in series relative to each other, to form a decorative light system 80, as shown in FIG. 2. In the preferred embodiment, the ends of adjacent housing portions 74 are formed so that they cooperate to form a continuous, or substantially continuous, system positioned in a preselected location on the structure 68 (FIGS. 2, 4, 18A, 18B).

Preferably, the housing 50 comprises steel, aluminium, or a durable plastic material such as polyvinylchloride (PVC). The apertures 64 can have round shapes, or can have any other shape, or shapes, desired. The spacing of the apertures 64 in the front wall 54 can be regular, so that the apertures 64 form a pattern, or the spacing can be random. It will also be appreciated that the support element 62 could, alternatively, be of solid construction.

The light source 52 is preferably a rope light. As is known in the art, a rope light typically includes an elongate translucent tube (usually comprising a flexible plastic material) with one or more incandescent light elements disposed inside the tube. Rope lights for producing light in a variety of colors are available.

In use, the housing 50 is positioned on the structure at a preselected location by the installer (not shown), and fasteners 72 are inserted through the fastener holes 70, to secure the housing 50 to the structure 68. The installer inserts the light source 52 into the housing 50, mounting the light source on the support element 62, which secures the light source 52 in the housing 50. Preferably, the support element 62 is deflected, or bent, to a closed position, to hold the light source 52 more securely in the housing 50. After the light source 52 is in place, another housing portion 50 is installed next to and adjacent to the first housing, and a light source 52 is also inserted and held therein. Each housing portion with a light source held therein comprises a housing and light assembly. Once all the housing portions required are in position on the structure (FIG. 2), electricity is provided to the light system comprising the plurality of housing and light assemblies. As can be seen in FIGS. 1C and 4, the housing and light assemblies provide both light transmitted through the apertures in the front walls and light transmitted through the opening 74 along the back of the housing (and through openings 63), to provide a backlighting effect. The overall effect of the light transmitted out of the housing both towards an observer (not shown) and away from the observer is aesthetically pleasing and unique.

Preferably, once attached, the housing 50 is allowed to remain in place on the structure 68, with the light source 52 therein. When the light source is not energized, the decorative light system is unobtrusive. For example, if the system is used primarily to provide a decorative lighting effect during the Christmas season, the system can be left in place throughout the year, and the annual household task of putting up and taking down Christmas lights is thereby done away with.

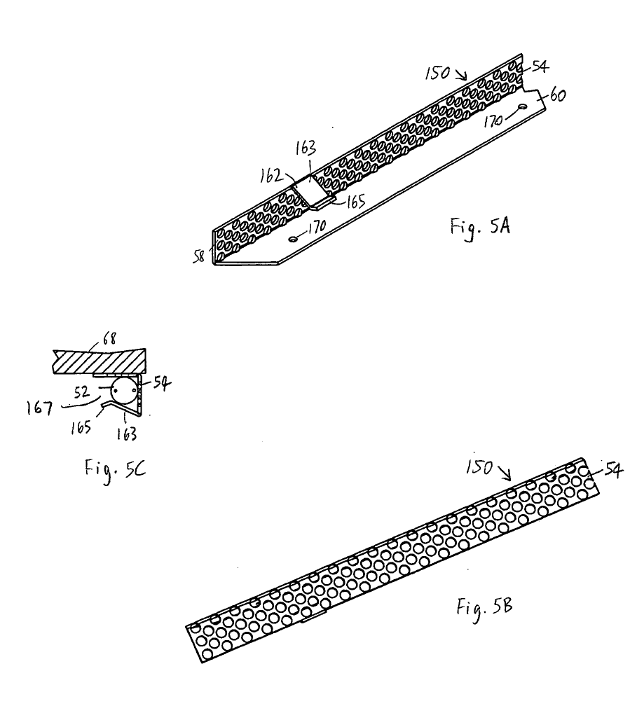

In an alternative embodiment shown in FIGS. 5A-5C, a housing 150 includes the front wall 54 and the first wall 60 and a support element 162 extending from the front wall 54. Preferably, the support element 162 extends from the interior side 58 of the front wall 54, and is movable between an open position (FIG. 5A) and a closed position (FIG. 5C). The light source 52 is receivable on the support element 162 (i.e., between the support element 162 and the first wall 60) when the support element 162 is in the open position. After the housing 150 has been attached to the structure 68 the light source 52 is positioned in the housing 150. Next, the support element 162 is bent to secure the light source 52 in the housing 150 so that the light source 52 is held in place between the support element 162, the interior side 58 of the front wall 54, and the first wall 60.

Preferably, the support element 162 is of solid construction (i.e., without an opening) and has a main portion 163 and a second portion 165. The second portion 165 is positioned at an angle relative to the main portion 163, and when the support element 162 is in a normal position (FIG. 5C), a gap 167 is defined between the second portion 165 and the first wall 60. The second portion 165 of the-support element 162 is positioned at an angle to the first portion 163 to assist in guiding the light source 52 into the gap 167, when the light source 52 is to be inserted into the housing 150. The light source 52 is then pressed into the gap 167 by-the installer, causing deflection of the support element 162 away from the first wall 60 (i.e., thereby widening the gap 167) sufficiently to enable the light source 52 to move through the gap 167 and into contact with the first portion 163. The support element 162 resiliently returns to its normal position after the light source 52 is located adjacent to the first portion 163, in which the gap 167 is insufficiently wide to permit the light source 52 through, so that the light source 52 is thereby held in the housing 150. It can be seen, therefore, that the support element 162 is not bent or deflected to a closed position in the same manner as the support element 62. This “snap-in” version of the support element is typically narrower than the bendable version of the support element, and may be used where the material comprising the housing is suitable. The snap-in version can provide somewhat quicker and easier installation, where the appropriate materials are used.

The support element 162 is located a preselected distance offset from the fastener hole 170 because the fastener (not shown) could not be passed through the solid support element 162. The support element 162 could, alternatively, have an opening therein (not shown). If the support element 162 had an opening therein, it could be located in alignment with a fastener hole. It will also be appreciated that the support element 62 (i.e., in housing 50) could, alternatively, be replaced by support element 162.

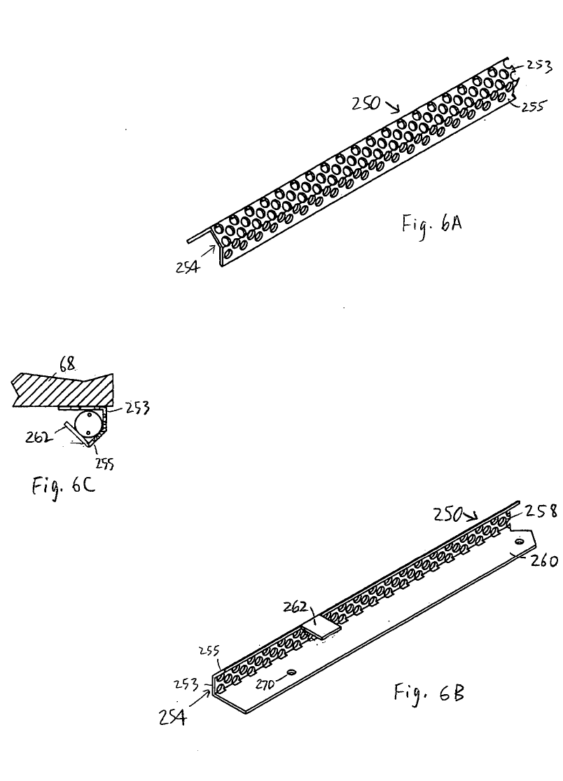

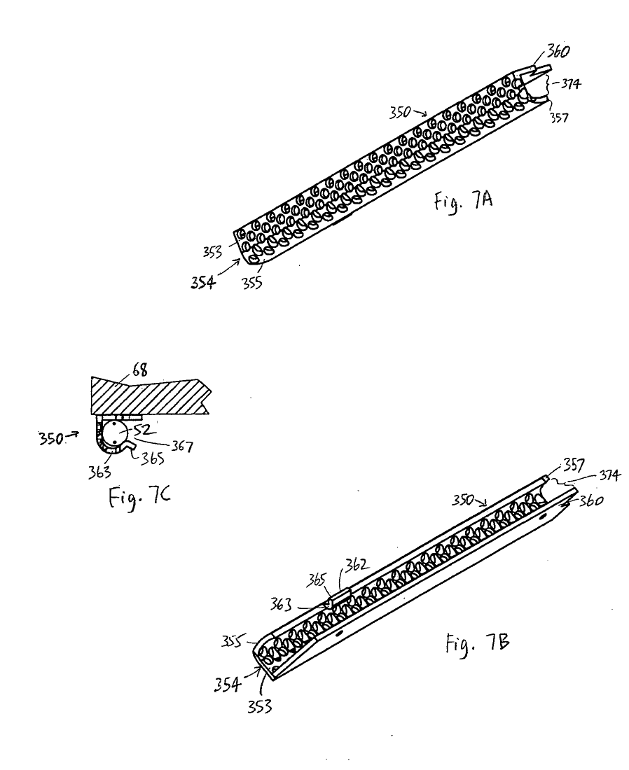

In another alternative embodiment shown in FIGS. 6A-6C, a housing 250 includes a front wall 254 and a first wall 260 extending from the front wall 254. The front wall 254 includes a first portion 253, from which the first wall 260 extends, -and a second portion 255. As can be seen in FIGS. 6A and 6C, the second portion 255 and the first portion 253 are both substantially planar, but they are positioned at an angle relative to each other. As can be seen in FIG. 6C, relatively more light can be directed downwardly and forwardly out of the housing 250 due to the positioning of the second portion 255 relative to the first portion 253, and the positioning of both relative to the light source 52 (FIG. 6C). The support element 262 is movable between an open position (FIG. 6B) and a closed position (FIG. 6C). Preferably, the support element 262 is solid, and is offset from the fastener hole 270. However, the support element 262 could, alternatively, include an opening therein (not shown).

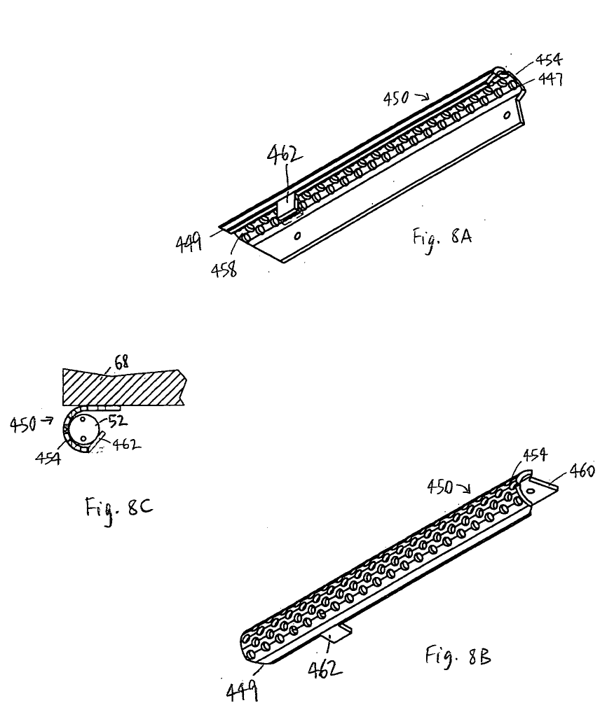

In another alternative embodiment shown in FIGS. 7A-7C, a housing 350 includes a front wall 354 which includes a substantially planar first portion 353 and a curved second portion 355 extending from the first portion 353. A first wall 360 also extends from the first portion 353, and the second portion 355 of the front wall 354 includes a distal end 357 which is spaced apart from the first wall 360 a distance sufficient to permit the light source 52 to be received between the distal end 357 and the first wall 360.

Preferably, the housing 350 includes a support element 362 of solid construction, for locating and retaining the light source 52 in the housing 350. As can be seen in FIGS. 7B and 7C, the support element 362 preferably includes a first portion 363 and a second portion 365 positioned at an angle relative to the first portion 363.

The support element 362, like the support element 162, is a “snap-in” support element. The second portion 363 is positioned to guide the light source 52 towards a gap 367 (between the support element 362 and the first wall 360), when the light source 52 is being inserted into the housing 350. As the light source 52 is pressed into the gap 367, the support element 362 deflects away from the first wall 360, causing the gap 367 to widen, thereby allowing the light source 52 through. The light source 52 is held in place by the support element 362 because, after deflection, the support element 362 resiliently returns to its normal position (FIG. 7C), in which the gap 367 is insufficiently wide to permit the light source 52 to pass therethrough. The light source 52 is thereby held in the housing 350.

As can be seen in FIG. 7C, the second portion 355 of the housing 350 provides support for the light source 52 along the length of the light source 52. Because of this, the support elements 362 can be relatively narrow, thereby making installation of the light source 52 somewhat easier. Also, the apertures 64 in the second portion 355 provide an aesthetically pleasing effect, in which light from the light source is directed through the apertures downwardly (through portion-355) and horizontally (through portion 353), as well as through the gap 367 and an opening 374 along the back of the housing 350, to provide a backlighting effect.

In another alternative embodiment shown in FIGS. 8A-8C, a housing 450 includes a curved front wall 454 with a first end 447, from which a first wall 460 extends, and a second end 449, from which a support element 462 extends. As can be seen in FIG. 8C, the front wall 454 is preferably curved so that the light source 52 fits within an interior side 458 of the front wall 454.

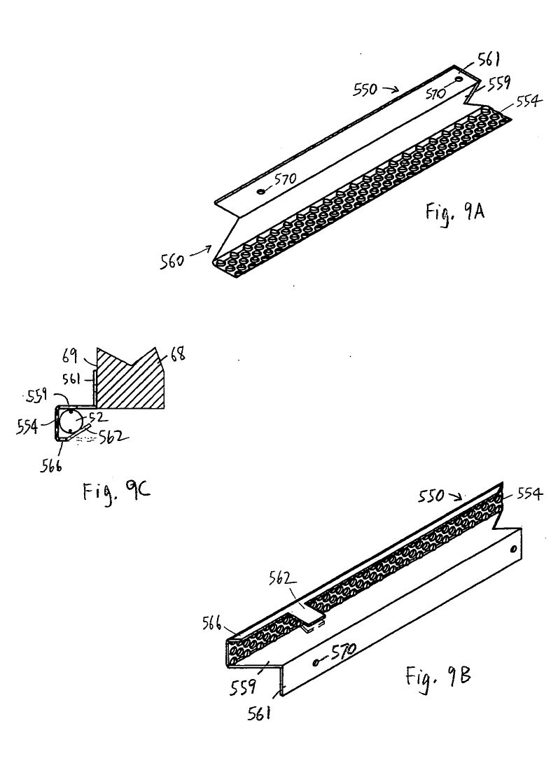

In another alternative embodiment shown on FIGS. 9A-9C, a housing 550 includes a front wall 554, a first wall 560 extending from the front wall 554, and a second wall 566 also extending from the front wall 554. The first wall includes a first portion 559 which is adjacent to the front wall, and a second portion 561 which preferably is positioned substantially orthogonally to the first portion 559. The second portion 561 preferably includes fastener holes 570. As can be seen in FIG. 9C, the position of the-second portion 561 relative to the first portion 559 can permit the front wall 554 to be positioned at a distance from a front surface 69 of the structure 68.

As can be seen in FIGS. 9C and 9D, the housing 550 preferably also includes a support element 562 which is movable between an open position and a closed position. When the support element 562 is in the open position, the second wall 566 and the support element 562 are spaced apart from the first portion 559 of the first wall 560 a distance sufficient to permit the light source 52 to be positioned between the first portion 559, on the one hand, and the second wall-566 and the support element 562, on the other hand. After the light source 52 is positioned in the housing 550, the support element 562 is bent to engage the light source 52 and press the light source 52 against the interior side 558 of the front wall 554 and also against the first portion 559.

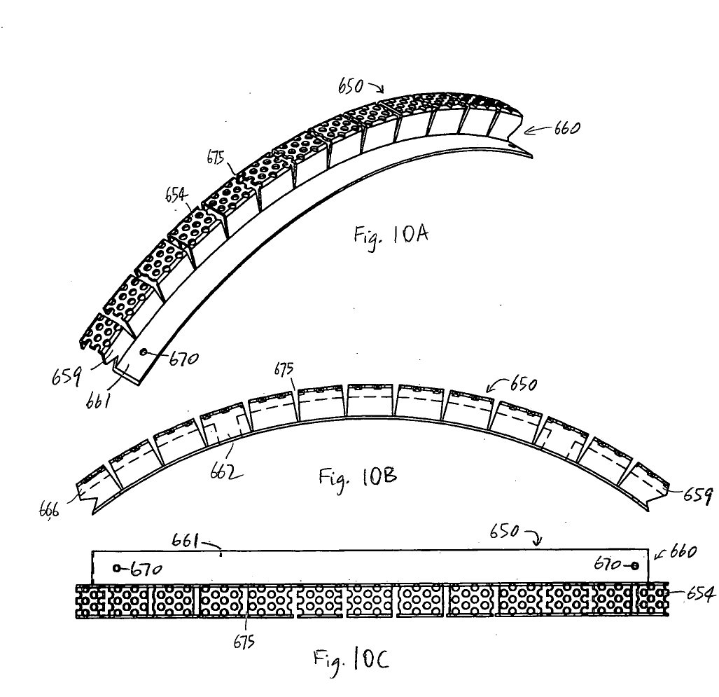

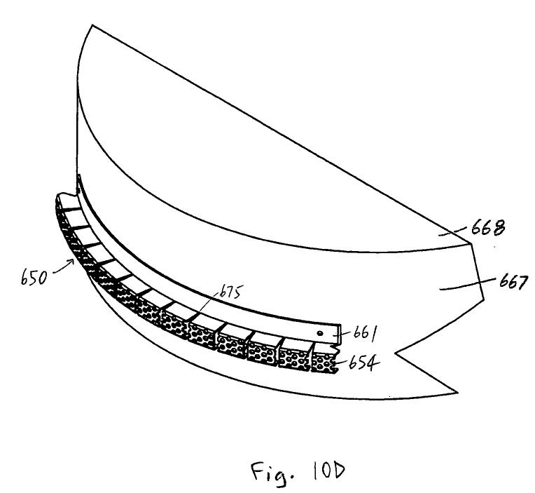

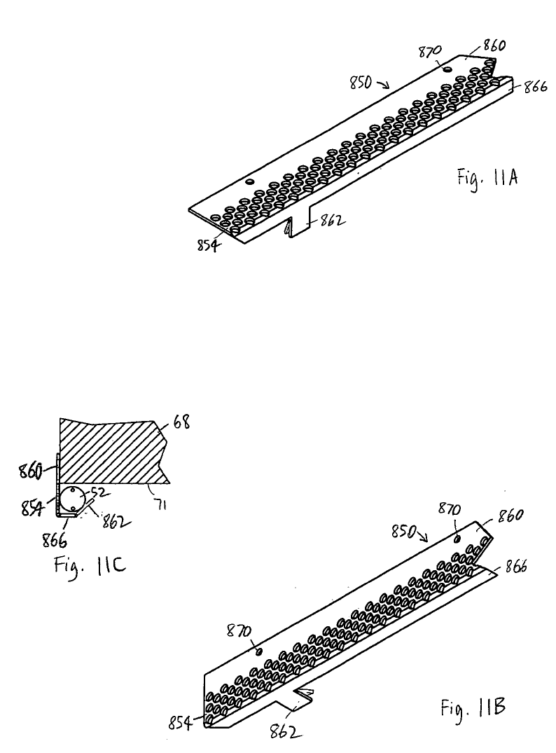

In another alternative embodiment shown in FIGS. 10A-10D, a housing 650 includes a front wall 654 and a first wall 660 extending from the front wall. The housing 650 also includes a second wall 666 (FIG. 10B) extending from the front wall 654, and a support element 662 extending from the second wall 666. The first wall 660 includes a first portion 659 and a second portion 661. The second portion 661 preferably includes fastener holes 670. As can be seen in FIGS. 10A-10C, the first portion 659 extends from the front wall 654, positioned substantially orthogonally to the front wall 654, and the second portion 661 extends substantially orthogonally to the first portion 659. The front wall 654 and the first portion 659 are divided by a series of cuts 675 which permit the housing 650 to be bent to conform with a curvilinear shape. Preferably, the cuts 675 are spaced apart a predetermined distance.

As can be seen in FIG. 10D, the housing 650 is bendable to conform to a curved surface 667 of a structure 668. Preferably, after the housing 650 has been bent to the appropriate curve, the housing 650 is attached to the curved surface 667 by fasteners (not shown) inserted through the fastener holes 670 and into the curved surface 667. Subsequently, the light source 52 is positioned in the housing 650, and then the support elements 662 are bent over the light source 52, to hold the light source 52 in the housing 650.

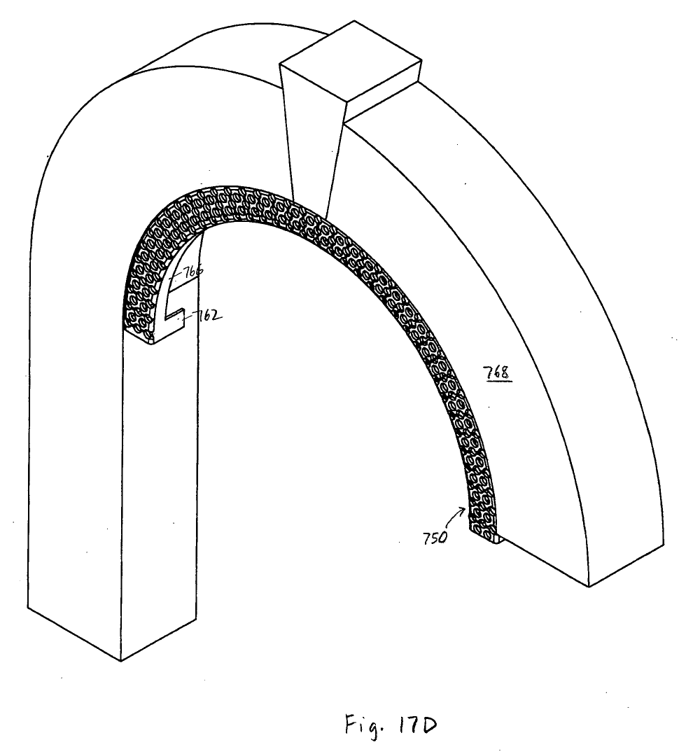

In another alternative embodiment shown in FIGS. 17A-17D, a housing 750 includes a front wall 754 and a first wall 760 extending from the front wall. The housing 750 also includes a second wall 766, also extending from the front wall 754, the second wail 766 being substantially parallel to the first wall 754. As can be seen in FIGS. 17A-17C, the front wall 754 and the second wall 766 are divided by a series of cuts 775 which permit the housing 750 to be bent to conform with a curvilinear shape. Support elements 762 extend from the second wall 766. Preferably, the cuts 775 are spaced apart a predetermined distance.

As can be seen in FIG. 17B, the housing 750 is bendable to conform to a curved surface formed by an arch structure 768. Preferably, after the housing 750 has been bent to the appropriate curve to conform with the curvature of the arch 768, the housing 750 is attached to the arch 768 by fasteners (not shown) inserted through the fastener holes 770 and into the arch structure 768. Subsequently, the light source 52 is positioned in the housing 750. The support elements 762 are then bent over the light source 52, to hold the light source 52 in the housing 750.

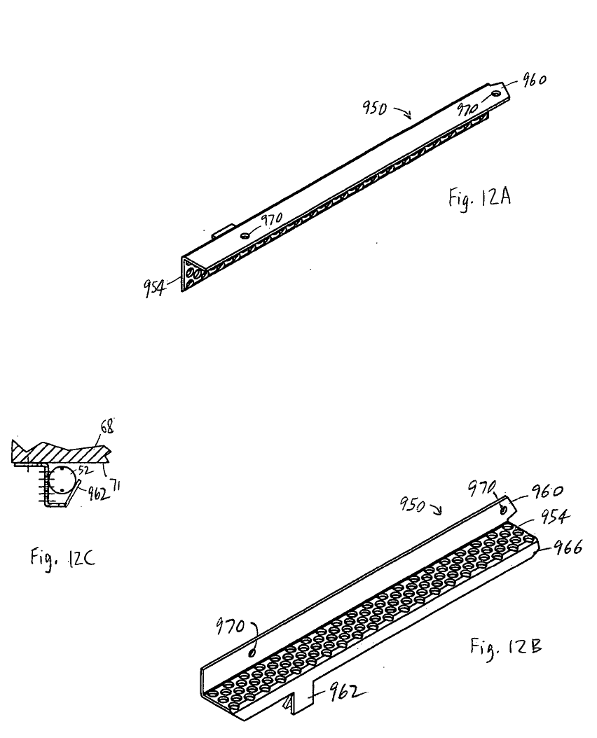

In another alternative embodiment shown in FIGS. 11A-11C, a housing 850 includes a substantially planar front wall 854, a substantially planar first wall 860 extending from the front wall 854, the first wall 860 and the front wall 854 being substantially co-planar. The housing 850 additionally includes a second wall 866 extending substantially orthogonally from the front wall 854 and a support element 862 extending from the second wall. Fastener holes 870 are preferably included in the first wall 860 (FIGS. 11A, 11B).

As can be seen in FIG. 11C, after the housing is attached to the structure 68, the light source 52 is positioned between the second wall 866 and a second surface 71 of the structure 68. The support element 862 is then bent from the open position to the closed position (FIG. 11C, so that the support element 862 urges the light source 52 into contact with each of the front wall 854, the second wall 866, and the second surface 71 of the structure 68.

In another alternative embodiment shown in FIGS. 12A-12C, a housing 950 includes a substantially planar front wall 954, and a substantially planar first wall extending from the first wall 960 extending from the front wall 954 in a first direction, as shown in FIGS. 12A and 12B. The first wall 960 includes fastener holes 970 therein. The housing 950 also includes a substantially planar second wall 966 extending from the front wall 954 in a second direction which is opposite to the first direction. Additionally, the housing 950 includes a support element 962 extending in the second direction and movable between an open position and a closed position.

As can be seen in FIG. 12C, the housing is mounted to the second surface 71 of the structure 68. The light source is positioned in the housing, i.e., between the second wall 966 and the second surface 71. The support element 962 is bent to the closed position in which the support element 962 urges the light source 52 against the front wall 954. In this embodiment, the light source 52 may also come into contact with the second surface 71 of the structure 68 (not shown).

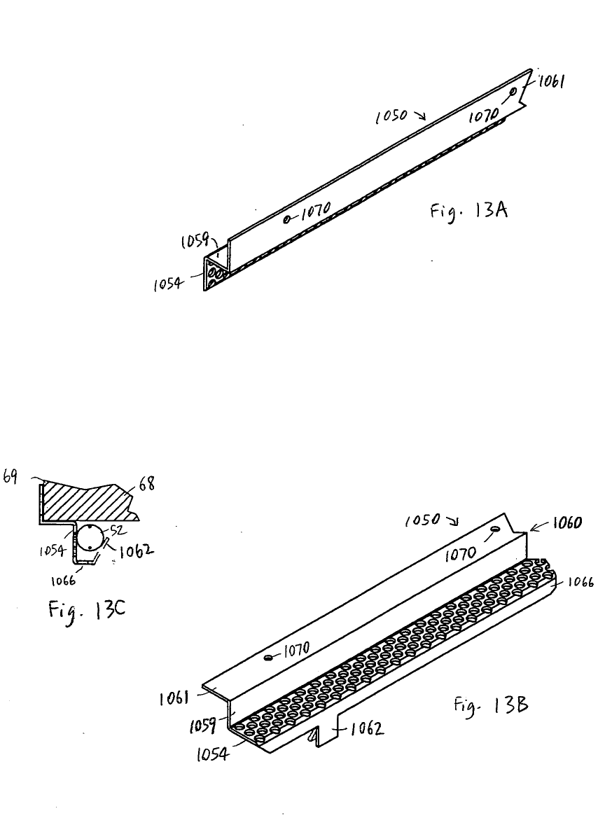

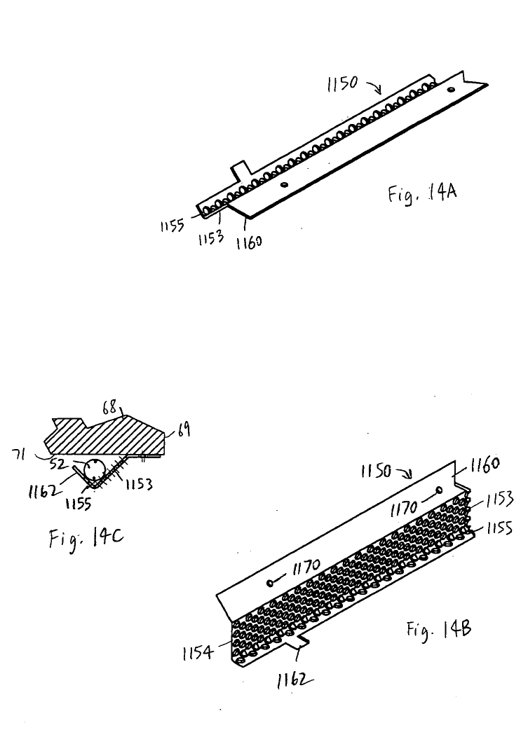

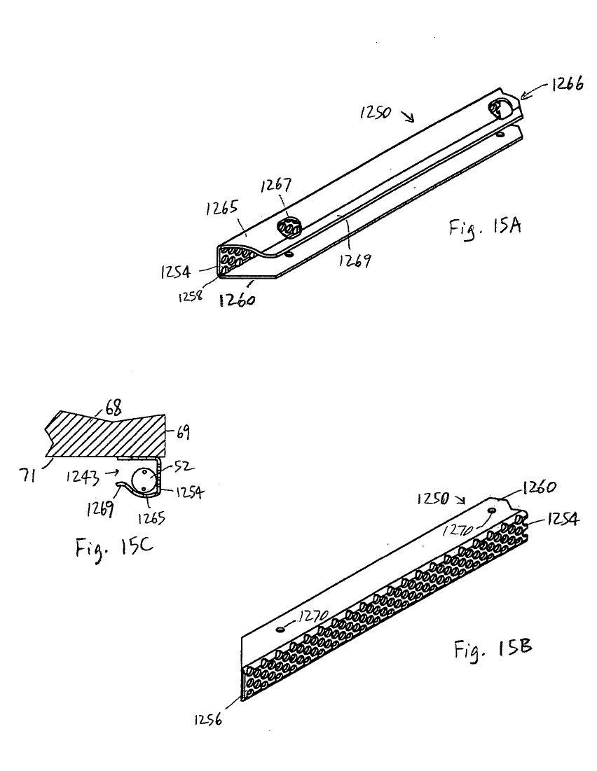

In another alternative embodiment shown in FIGS. 13A-13C, a housing 1050 includes a substantially planar front wall 1054, a first wall 1060 having a substantially planar first portion 1059 extending in a first direction from the front wall 1054 and positioned substantially orthogonally to the front wall 1054, and including a second portion 1061. Preferably, the second portion 1061 is substantially planar and extends from the first portion 1059 in a direction away from the front wall 1054. The second portion 1061 includes fastener holes 1070. The housing 1050 also preferably includes a second wall 1066 extending substantially orthogonally from the front wall 1054 in a second direction which is substantially opposite to the first direction. Finally, the housing 1050 additionally includes a support element 1062 extending from the second wall 1066 in the second direction.

As can be seen in FIG. 13C, the second portion 1060 preferably is fastened to the front surface 69 of the structure 68. Because of the positioning of the second portion 1060 and the first portion 1059 relative to each other and relative to the front wall 1054, the light source 52, when held in the housing 1050, is offset back from the front surface 69. The support element 1062 is bent so that it urges the light source 52 against the front wall 1054, to hold the light source 52 in the housing 1050.

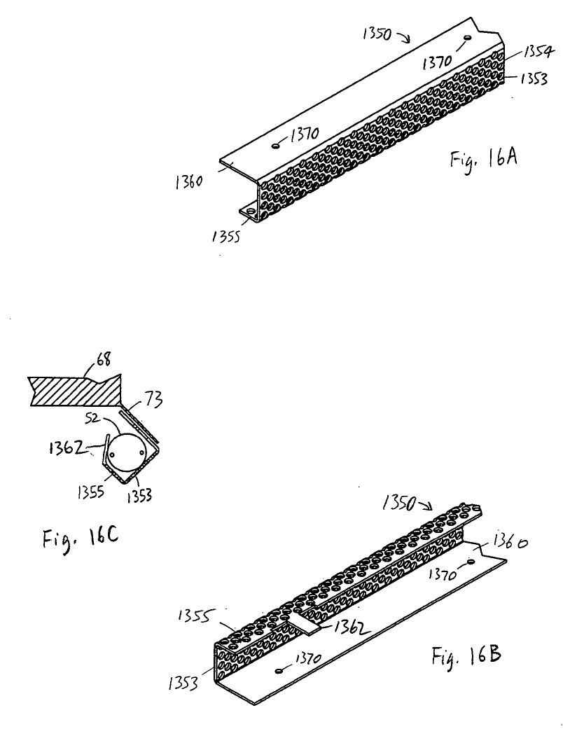

In another alternative embodiment shown in FIGS. 14A-14C, a housing 1150 includes a front wall 1154 including a substantially planar first portion 1153 and a curved second portion 1155. Preferably, the housing 1150 includes a first wall extending from the first portion in a first direction away from the second portion. Additionally, the housing 1150 preferably includes one or more support elements 1162 extending from the curved second portion 1155 of the front wall 1154. As can be seen in FIG. 14C, the first wall 1160 is attached to the second surface 71 of the structure 68. The light source 52 is preferably positioned in the housing, held between the first portion 1153 and the second portion 1155 of the front wall 1154.

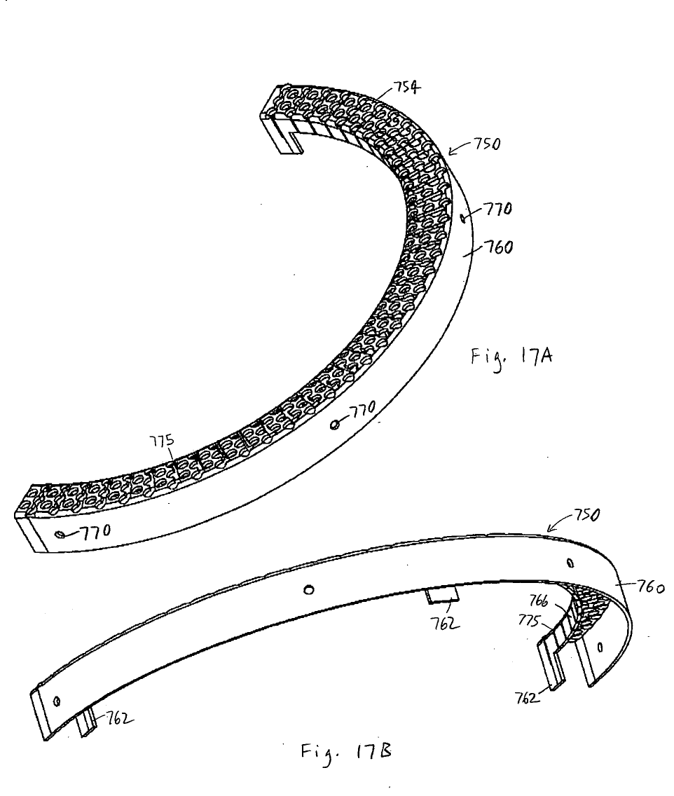

In yet another alternative embodiment shown in FIGS. 15A-15C, a housing 1250 includes a substantially planar front wall 1254, with a substantially planar first wall 1260 extending therefrom substantially orthogonally to the front wall 1254. The front wall 1254 has an exterior side 1256 and an opposed interior side 1258. Fastener holes 1270 are included in the first wall 1260. The housing 1250 additionally includes a second wall 1266 extending from the interior side 1258 of the front wall 1254. The second wall 1266 includes apertures 1267 which are substantially aligned with the fastener-holes 1270 in the first wall 1260. The apertures 1267 permit fasteners to be passed there through and into the fastener holes 1270 when the housing 1250 is attached to the structure 68.

As can be seen in FIGS. 15A and 15C, the second wall 1266 preferably includes a first portion 1265-which is curved to receive the light source 52, and a second portion 1269 which extends towards the first wall 1260. As can be seen in FIG. 15C, the gap 1243 between the first wall 1260 and the second portion 1269 is substantially less than the diameter of the light source 52. As can be seen in FIG. 15C, in order for the light source 52 to be inserted in the housing 1250, the second portion 1269 is deflected (not shown), to enable the light source 52 to be inserted in the housing 1250. Because of the flexibility needed to enable the second portion 1269 to deflect sufficiently, the housing 1250 is preferably made of PVC or other suitable material with sufficient flexibility. After the insertion of the light source 52 through the gap 1243, the second portion 1269 returns to its original position (FIG. 15C) so that it holds the light source 52 in the housing 1250.

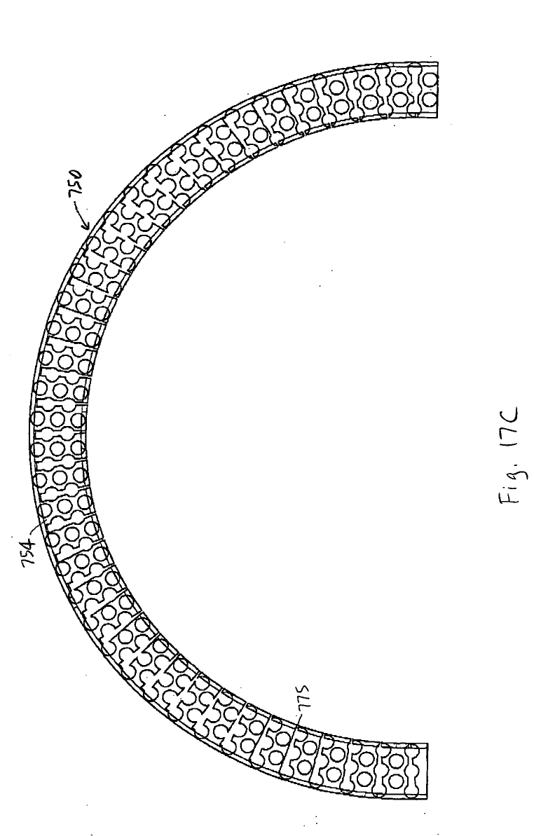

In yet another alternative embodiment shown in FIGS. 16A-16C, a housing 1350 includes a front wall 1354 having a substantially planar first portion 1353 and a substantially planar second portion 1355 positioned orthogonally to the first portion 1353 and extending in a first direction therefrom. The housing 1350 additionally includes a first wall 1360 with fastener holes 1370 therein. Preferably, the housing 1350 additionally includes support elements 1362 movable between an open position (FIG. 16B) and a closed position (FIG. 16C).

As can be seen in FIG. 16C, the housing 1350 can be used where, for example, the structure 68 includes an extension part 73 to which the first wall 1360 is attached.

As shown in FIGS. 18A and 18B, a housing and light assembly 174 can be prepared for installation with a light source 152 having a predetermined length, and connectors 151, 153 at opposite ends thereof. Preferably, the connector 151 is adapted for use with an electrical power cord 155 to provide electricity to the light source 152 from a source (not shown). The connector 153 is preferably adapted to cooperate with a connector 251 positioned in a light source 252 in an -adjacent housing portion (not shown). When the housing portions are positioned on the structure, the light sources 152 and 252 are joined together at the connectors 153, 251 so that electrical current can reach the light sources 152, 252. By means of such connectors, a series of housing portions, each containing a light source, can be connected together to form a decorative lighting system attached to a structure, such as a house.

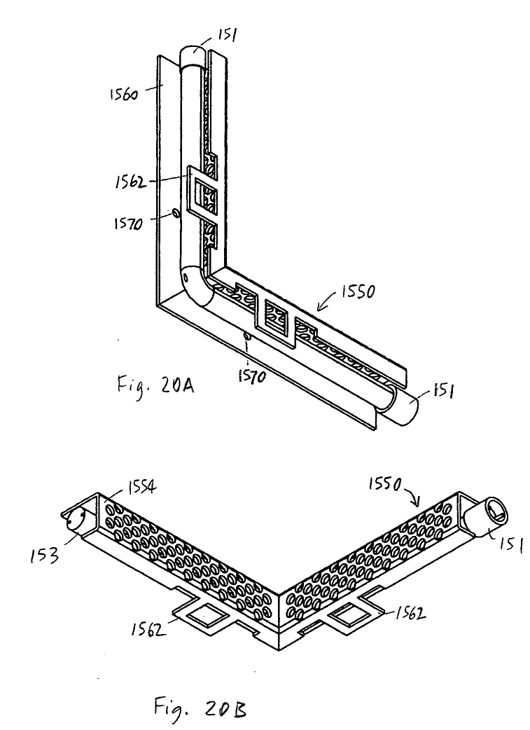

An additional embodiment 1450 of the housing is shown in FIGS. 19A and 19B, with the light source 152 positioned therein. The housing 1450 is formed to conform with a corner in a structure (not shown) to which the housing 1450 is to be attached. As can be seen in FIG. 19B, the housing 1450 includes fastener holes 1470 through which fasteners can be inserted in order to secure the housing 1450 to the structure. The housing 1450 also includes support elements 1462 which are shown in the open position in FIG. 19B for greater clarity.

The housing 1450 is preferably formed out of a substantially straight housing portion. After the dimensions of the corner in the structure are obtained, angled cuts re made in the front wall 1454 and in the second wall 1466. Preferably, the first wall 1460 is then bent to conform with the corner in which the housing 1450 is to be attached.

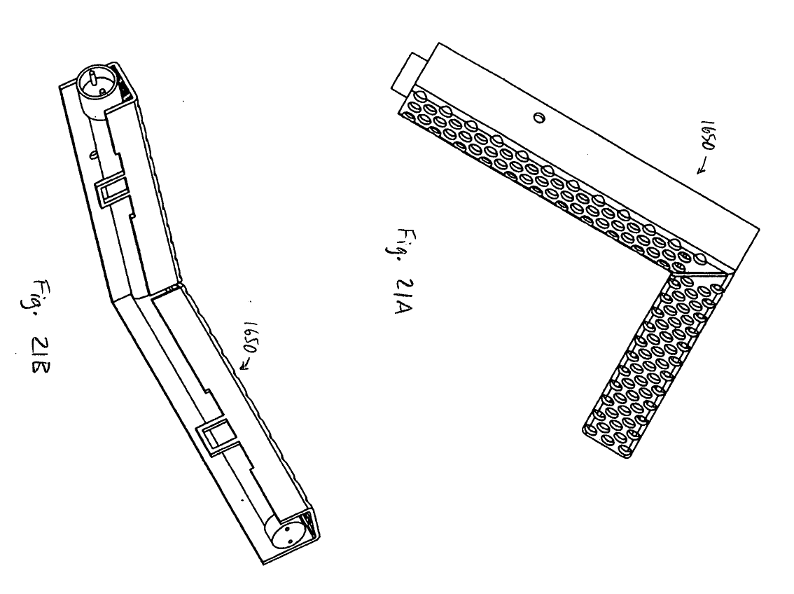

Another alternative embodiment of a housing 1550, with the light source 152 held therein, is shown in FIGS. 20A and 20B. The housing 1550 is formed to fit in an inwardly-directed 900 corner. The housing 1550 includes a first wall 1560 extending from a front wall 1554, and fastener holes 1570 are included in the first wall 1560. The support elements 1562 are shown in the open position for clarity. The housing 1550 preferably is formed by welding two housing potions (of suitable materials) together in the appropriate configuration.

Yet another alternative embodiment of a housing 1650 is shown in FIGS. 21A and 21B. The housing 1650 is formed to fit into a peak on a structure 68. Preferably, the housing 1650 is made of a suitable material which can be bent into a shape and retain its shape afterwards, so that the housing 1650 can be formed to fit into a peak in a manner similar to the manner in which the housing 1450-is formed (described above).

The housing can be made of any suitable material. Preferably, the housing is made of material which is suitably resilient, where necessary, and otherwise which can be formed into the appropriate shapes, as required. The housing permits light to be directed from the light source positioned therein outwardly, through the front wall, and through an opening formed generally between the first wall and the second wall, i.e., in those embodiments of the housing which include a second wall. In the embodiments lacking a second wall, the opening is formed between the first wall and a distal end of the front wall. The result is to provide a decorative lighting system in which the observer can see light from the light source which is transmitted through the front wall as well as light simultaneously transmitted through the opening which provides a backlighting effect.

It will be evident to those skilled in the art that the invention can take many forms, and that such forms are within the scope of the invention as claimed. Therefore, the spirit and scope of the appended claims should not be limited to the description of the preferred versions contained herein.

1. A housing for holding at least one light source, the housing having:
a front wall with an exterior side and an opposed interior side;
a first wall extending from the interior side; and
at least one support element for locating said at least one light source in the housing, the support element extending from the interior side of the front wall.

2. A housing according to claim 1 in which the front wall includes a plurality of apertures such that light from said at least one light source held in the housing is transmittable through said apertures.

3. A housing according to claim 1 in which said at least one support element comprises a tab movable between an open position, in which said at least one light source is receivable on the tab, and a closed position, in which the tab holds said at least one light source in the housing.

4. A housing according to claim 1 additionally including a second wall extending from the interior side of the front wall, the second wall being spaced apart from the first wall a predetermined distance sufficient to permit said at least one light source to be received therebetween.

5. A housing according to claim 1 in which the first wall is substantially planar.

6. A housing according to claim 5 additionally including a substantially planar second wall extending from the interior side of the front wall and positioned substantially parallel to the first wall, the second wall being spaced apart from the first wall a predetermined distance sufficient to permit said at least one light source to be received therebetween.

7. A housing for holding at least one light source, the housing having:
a front wall with an interior side and an opposed exterior side;
a first wall extending from the interior side of the front wall; and
a second wall extending from the interior side of the front wall and spaced apart from the first wall a predetermined distance sufficient to permit said at least one light source to be held in the housing between the first wall and the second wall.

8. A housing according to claim 7 in which the second wall includes at least one support element for locating said at least one light source in the housing, said at least one support element being movable between an open position, in which said at least one light source is receivable between the support element and the first wall, and a closed position, in which the light source is secured in the housing by said at least one support element.

9. A housing for holding at least one light source, the housing having:
a front wall with an exterior side and an opposed interior side;
a first wall extending from the front wall; and
at least one support element for locating said at least one light source in the housing, the support element extending from the interior side of the front wall.

10. A housing according to claim 9 in which the front wall includes a plurality of apertures such that light from said at least one light source held in the housing is transmittable through said apertures.

11. A housing according to claim 9 in which the front wall is cut into a plurality of segments of preselected length, each said segment being attached,.to--, the first wall such that the housing is bendable to conform to a preselected curve on a structure.

12. A housing according to claim 11 in which the first wall includes a first portion extending from the interior side and a second portion extending from the first portion, the first portion being cut into a plurality of wall segments to permit the housing to be bent to conform to a curved portion of the structure.

13. A housing and light assembly having:
a front wall with an exterior side and an opposed interior side;
a first wall extending from the interior side;
at least one support element extending from the interior side of the front wall; and
at least one light source supported by said at least one support element.

14. A housing and light assembly according to claim 13 in which said at least one light source is held in the housing adjacent to the interior side of the front wall.

15. A housing and light assembly according to claim 13 in which said at least one light source is adapted for use with an external source of electric current, said electric current being supplied to said light source at a first end of the housing, the housing including an electrical power plug at an opposed second end of the housing, the plug being adapted to cooperate with another electrical plug on an adjacent housing and light assembly, to permit electric current to pass through the plug to the adjacent housing and light assembly.

16. A housing and light assembly according to claim 13 in which the front wall includes a plurality of apertures such that light from said at least one light source is transmittable through said apertures.

17. A housing and light assembly according to claim 13 in which said at least-one support element comprises a tab movable between an open position, in which said at least one light source is receivable on the tab, and a closed position, in which the tab holds said at least one light source in the housing.

18. A housing and light assembly according to claim 13 additionally including a second wall extending from the interior side of the front wall, the second wall being spaced apart from the first wall a predetermined distance sufficient to permit said at least one light source to be received therebetween.

19. A housing and light assembly according to claim 13 in which the first wall is substantially planar.

20. A housing and light assembly according to claim 19 additionally including a substantially planar second wall extending from the interior side of the front wall and located substantially parallel to the first side, the second wall being spaced apart from the first wall a predetermined distance sufficient to permit said at least one light source to be received therebetween.

21. A decorative light system adapted for attachment to a structure, the system having:
a housing adapted for attachment to the structure, the housing having:
a front wall with an exterior side and an opposed interior side;
a first wall extending from the interior side;
at least one-support element for locating the light source in the housing, the support element extending from the interior side of the front wall;
a plurality of fasteners for securing the first wall to the structure, the first wall being adapted to cooperate with said fasteners such that the first wall is thereby securable to the structure;
the housing being positionable on the structure; and
at least one light source receivable on said at least one support element, for providing light which is transmittable out of the housing.

22. A decorative light system according to claim 21 in which said at least one light source is a rope light.

23. A decorative light system according to claim 21 in which the front wall includes a plurality of apertures to permit light from said at least one light source to be transmitted through the front wall.

24. A decorative light system according to claim 21 in which said at least one support element comprises a tab movable between an open position, in which said at least one light source is receivable on the tab, and a closed position, in which the tab holds said at least one light source in the housing.

25. A decorative light system according to claim 21 additionally including a second wall extending from the interior side of the front wall, the second wall being spaced apart from the first wall a predetermined distance sufficient to permit said at least one light source to be received therebetween.

26. A decorative light system according to claim 25 in which the second wall includes a plurality of openings adapted to permit light from said at least one light source to be transmitted therethrough.

27. A method of attaching a decorative light system at at least one preselected location on a structure, the method comprising the steps of:
(a) providing a plurality of housing portions adapted for attachment to the structure, each said housing portion including:
a front wall with an exterior side and an opposed interior side;
a first wall extending from the interior side;
at least one support element for locating the light source in the housing, the support element extending from the interior side of the front wall;
(b) securing the first wall at said at least one preselected location on the structure;
(c) inserting at least one light source in each said housing portion;
(d) securing said at least one light source with said at least one support element in each said housing portion; and
(e) providing electricity to said at least one light source.
